(19) United States
(12) Patent Application Publication
(10) Pub. No.: US 2005/0205009 A1
(43) Pub. Date: Sep. 22, 2005

(54) Swivel joint assembly for interconnecting hot melt adhesive supply hose and applicator components

(75) Inventor: Andrew S. Ayers, Old Hickory, TN (US)

Correspondence Address: Steven W. Weinrieb;SCHWARTZ & WEINRIEB, Crystal Plaza One, Suite 1109, 2001 Jefferson Davis Highway, Arlington, VA, 22202, US

(73) Assignee: ILLINOIS TOOL WORKS INC.

(21) Appl. No.: 10/786,019

(22) Filed: Feb. 26, 2004

(51) Int. Cl. B05C 5/00

(52) U.S. Cl. 118/300

(57) ABSTRACT

A new and improved swivel joint assembly, for use within a hot melt adhesive applicator or dispensing system, comprises an annular array of ball bearing members which is interposed between the housing section of the swivel joint assembly, to which the hot melt adhesive inlet supply hose is connected, and the shaft section of the swivel joint assembly, to which the hot melt adhesive applicator is connected, so as to readily facilitate the smooth rotation of the shaft section of the swivel joint assembly with respect to the housing section of the swivel joint assembly when the hot melt adhesive applicator is disposed in its deactivated state at which time the pressure within the swivel joint assembly is substantially elevated. In this manner, the hot melt adhesive applicator can in fact be readily and easily moved from its predetermined DISPENSING position or orientation to its predetermined NON-DISPENSING position or orientation in order to accommodate or permit the movement of auxiliary apparatus into engagement with at least one of two structural components to be adhered together, and upon at least one of such structural components there has previously been deposited the predetermined amount of hot melt adhesive, so as to in fact cause the adherence together of the two structural components. In addition, special packing materials are incorporated within the swivel joint assembly so as to provide the necessary sealing of the swivel joint assembly in connection with the handling or flow of the hot melt adhesive materials therethrough without experiencing or undergoing thermal deterioration.

### FIELD OF THE INVENTION

The present invention relates generally to hot melt adhesive applicator or dispensing systems, and more particularly to a new and improved hot melt adhesive swivel joint assembly, for use within a hot melt adhesive applicator or dispensing system, which comprises a housing section to which the hot melt adhesive inlet supply hose is connected, a shaft section to which the hot melt adhesive applicator is connected, and a ball bearing assembly operatively interposed between the housing section and the shaft section for readily permitting or facilitating the rotation of the shaft section, and the hot melt adhesive applicator connected thereto, with respect to the housing section, and the hot melt adhesive inlet supply hose connected thereto, under high or “dead-head” pressure conditions attendant a non-application phase of the hot melt adhesive application cycle, such as, for example, when the hot melt adhesive applicator is deactivated in preparation for moving the hot melt adhesive applicator from a DISPENSING position or orientation, to a NON-DISPENSING position or orientation, in order to permit auxiliary apparatus to engage at least one of two structural components, upon at least one of which a predetermined amount of hot melt adhesive has been previously deposited, so as to cause the adherence together of the two structural components.

### BACKGROUND OF THE INVENTION

In connection with the dispensing of hot melt adhesives, a typical deposition or application cycle comprises the disposition of a hot melt adhesive applicator at a predetermined DISPENSING position or orientation, the activation of the hot melt adhesive applicator so as to dispense, discharge, and apply a predetermined amount of hot melt adhesive from the hot melt adhesive applicator onto predetermined regions of at least one of two structural substrates to be adhered together, the deactivation of the hot melt adhesive applicator and the subsequent movement of the hot melt adhesive applicator from the predetermined DISPENSING position or orientation to a predetermined NON-DISPENSING position or orientation in order to accommodate the movement of auxiliary apparatus into engagement with at least one of the two structural components so as to cause the adherence together of the two structural components, the movement of the auxiliary apparatus from a DISENGAGEMENT position with respect to the two structural components to an ENGAGMENT position with respect to at least one of the two structural components, upon at least one of which there has previously been deposited the predetermined amount of hot melt adhesive, so as to in fact cause the adherence together of the two structural components, the subsequent movement of the auxiliary apparatus back to the DISENGAGMENT position with respect to the two structural components so as to permit the hot melt adhesive applicator to again be disposed at the predetermined DISPENSING position or orientation in preparation for a subsequent hot melt adhesive dispensing, discharging, and application operation in connection with two new structural components, and the movement of the hot melt adhesive applicator back to the predetermined DISPENSING position or orientation so as to in fact achieve the subsequent hot melt adhesive dispensing, discharging, and application operation in connection with the two new structural components.

It is further known in connection with the dispensing of hot melt adhesives, and, in particular, during a typical deposition or application cycle, that when the hot melt adhesive applicator is disposed in its deactivated state, the pressure within the swivel joint assembly is substantially elevated to what is commonly known in the industry as “deadhead pressure”. Under such conditions, the pressure can reach a pressure level which is within the range of, for example, 300-800 psi. As a result of such elevated pressure conditions attendant, for example, the inactive stage of the hot melt adhesive dispensing or application cycle, conventional swivel joint assemblies, defined between the housing section, to which the hot melt adhesive inlet supply hose is connected, and the shaft section, to which the hot melt adhesive applicator is connected, often experience “hydraulic lock” whereby the shaft section, to which the hot melt adhesive applicator is connected, often cannot be rotated. Accordingly, the hot melt adhesive applicator is incapable of being moved from the aforenoted predetermined DISPENSING position or orientation to the predetermined NON-DISPENSING position or orientation, or if such movement is in fact possible, it is often extremely difficult to achieve and can usually be achieved only as a result of the galling or scarring of the relatively movable components. This phenomena may in fact lead to additional frictional and seizure problems for the movable components.

It is also to be appreciated that the aforenoted operational movements between the relatively movable components are exacerbated by means of the fact that since the system or assembly has hot melt adhesive materials flowing therethrough, the structural components are subjected to elevated temperature conditions which tend to cause the system or assembly components to undergo thermal expansion. Still further, hot melt adhesive materials are normally characterized by means of relatively high viscosity values which would also militate against achieving substantially easy and smooth relative rotation between the aforenoted system or assembly components.

A need therefore exists in the art for a new and improved swivel joint assembly, for use within a hot melt adhesive applicator or dispensing system, which is uniquely capable of facilitating rotation of the shaft section of the swivel joint assembly, to which the hot melt adhesive applicator is connected, with respect to the housing section, to which the hot melt adhesive inlet supply hose is connected, when the hot melt adhesive applicator is disposed in its deactivated state, at which time the pressure within the swivel joint assembly is substantially elevated to what is commonly known in the industry as “dead-head pressure”, whereby the hot melt adhesive applicator can in fact be readily and easily moved from its predetermined DISPENSING position or orientation to its predetermined NON-DISPENSING position or orientation in order to accommodate or permit the movement of auxiliary apparatus into engagement with at least one of two structural components to be adhered together, and upon at least one of such structural components there has previously been deposited the predetermined amount of hot melt adhesive, so as to in fact cause the adherence together of the two structural components.

### SUMMARY OF THE INVENTION

The foregoing and other objectives are achieved in accordance with the teachings and principles of the present invention through the provision of a new and improved swivel joint assembly, for use within a hot melt adhesive applicator or dispensing system, which comprises an annular array of ball bearing members which is interposed between the housing section of the swivel joint assembly, to which the hot melt adhesive inlet supply hose is connected, and the shaft section of the swivel joint assembly, to which the hot melt adhesive applicator is connected, so as to readily facilitate the smooth rotation of the shaft section of the swivel joint assembly, to which the hot melt adhesive applicator is connected, with respect to the housing section of the swivel joint assembly, to which the hot melt adhesive inlet supply hose is connected, when the hot melt adhesive applicator is disposed in its deactivated state, at which time the pressure within the swivel joint assembly is substantially elevated to what is commonly known in the industry as “dead-head pressure”. In this manner, the hot melt adhesive applicator can in fact be readily and easily moved from its predetermined DISPENSING position or orientation to its predetermined NON-DISPENSING position or orientation in order to accommodate or permit the movement of auxiliary apparatus into engagement with at least one of two structural components to be adhered together, and upon at least one of such structural components there has previously been deposited the predetermined amount of hot melt adhesive, so as to in fact cause the adherence together of the two structural components. In addition, special packing materials, such as, for example, FKM(VITON)®, which is a fluorocarbon elastomer manufactured by DUPONT®, or alternatively, FFKM(KALREZ)®, which is a perfluoro elastomer also manufactured by DUPONT®, are disposed within the swivel joint assembly so as to provide the necessary sealing of the swivel joint assembly in connection with the handling or flow of the hot melt adhesive materials therethrough.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a side elevational view, partly in cross-section, of a first linear or in-line embodiment of a new and improved swivel joint assembly, constructed in accordance with the principles and teachings of the present invention, and adapted for use within a hot melt adhesive applicator or dispensing system, wherein there is disclosed the special packing members, for sealing the swivel joint assembly through which hot melt adhesive materials are being conducted, and the annular array of ball-bearings members, as being interposed between the housing section of the swivel joint assembly, to which the hot melt adhesive inlet supply hose is connected, and the shaft section of the swivel joint assembly, to which the hot melt adhesive applicator is connected, so as to readily facilitate the smooth rotation of the shaft section of the swivel joint assembly, to which the hot melt adhesive applicator is connected, with respect to the housing section of the swivel joint assembly, to which the hot melt adhesive inlet supply hose is connected, despite the presence of substantially elevated pressure conditions within the swivel joint assembly such as, for example, when the hot melt adhesive applicator is disposed in its deactivated state; and

FIG. 2 is a side elevational view, partly in cross-section, similar to that of FIG. 1 showing, however, a second 90° elbow embodiment of a new and improved swivel joint assembly, constructed in accordance with the principles and teachings of the present invention, and adapted for use within a hot melt adhesive applicator or dispensing system, wherein there is likewise disclosed the special packing members, for sealing the swivel joint assembly through which hot melt adhesive materials are being conducted, and the annular array of ball-bearings members, as being interposed between the housing section of the swivel joint assembly, to which the hot melt adhesive inlet supply hose is connected, and the shaft section of the swivel joint assembly, to which the hot melt adhesive applicator is connected, so as to readily facilitate the smooth rotation of the shaft section of the swivel joint assembly, to which the hot melt adhesive applicator is connected, with respect to the housing section of the swivel joint assembly, to which the hot melt adhesive inlet supply hose is connected, despite the presence of substantially elevated pressure conditions within the swivel joint assembly such as, for example, when the hot melt adhesive applicator is disposed in its deactivated state.

### DETAILED DESCRIPTION OF THE PREFERRED EMBODIMENT

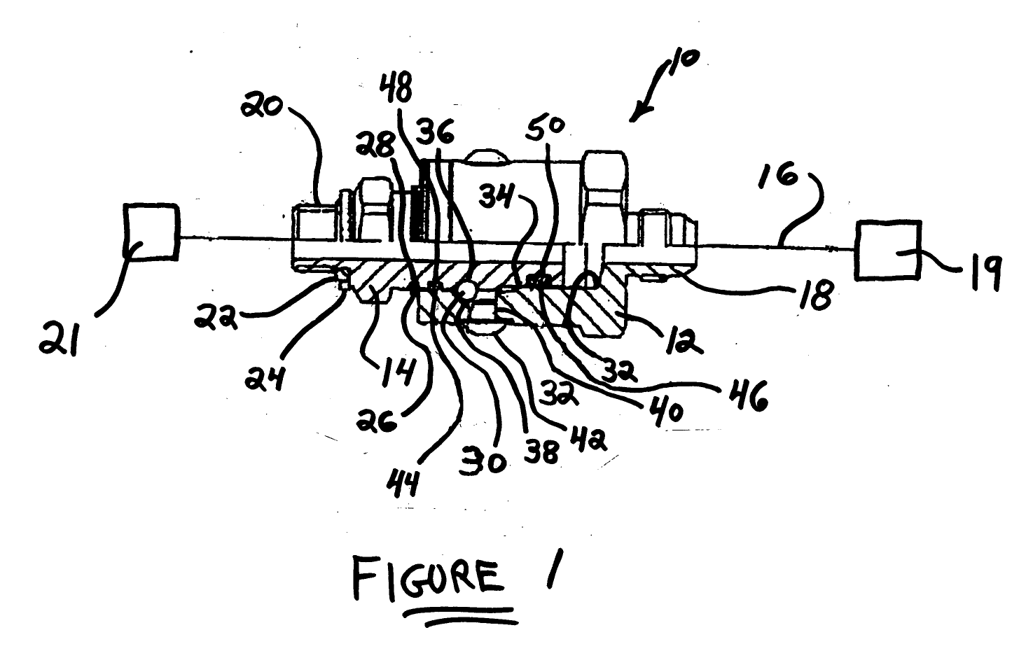

Referring now to the drawings, and more particularly to FIG. 1 thereof, a first embodiment of a new and improved swivel joint assembly, constructed in accordance with the principles and teachings of the present invention, and adapted for use within a hot melt adhesive applicator or dispensing system, is disclosed and is generally indicated by the reference character 10. The swivel joint assembly 10 is seen to comprise two primary or major structural components, that is, an outer or external housing member 12, and an inner or internal shaft member 14 which is adapted to rotate with respect to the outer or external housing member 12 around the longitudinal axis 16. In accordance with particular adaptation of the outer or external housing member 12, and the inner or internal shaft member 14, for use in connection with hot melt adhesive applications, the outer or external housing member 12 has a first threaded connector member 18 integrally formed upon the right end portion thereof, as viewed in the drawing figure, such that a hot melt adhesive supply hose, schematically shown at 19, can be threadedly and fluidically connected to the housing member 12, and in a similar manner, the inner or internal shaft member 14 has a second threaded connector member 20 integrally formed upon the left end portion thereof, as viewed in the drawing figure, such that a hot melt adhesive applicator, schematically shown at 21, can be threadedly and fluidically connected to the shaft member 14. An O-ring member 22 is disposed at the interface defined between the shaft member 14 and the second threaded connector member 20 so as to effectively seal the fluidic connection defined between the shaft member 14 and the hot melt adhesive applicator 21, and a first retaining ring 24 is provided in conjunction with the O-ring member 22 so as to maintain the O-ring member 22 in place upon the shaft member 14.

In a somewhat similar manner, it is appreciated that the inner or internal shaft member 14 is adapted to be axially inserted into the left, open end portion of the outer or external housing member 12, and in order to retain and maintain the inner or internal shaft member 14 within the outer or external housing member 12, a second annular retaining ring 26 is disposed at the interface defined between the external surface portion of the inner or internal shaft member 14 and the left, open end portion of the outer or external housing member 12. More particularly, it is to be appreciated that the second annular retaining ring 26 is adapted to be seated within an annular recess 28 defined within the external surface portion of the inner or internal shaft member 14, and in this manner, once the second annular retaining ring 26 is disposed within the annular recess 28, axial movement of the inner or internal shaft 14, with respect to the outer or external housing member 12, is effectively prevented.

Continuing further, with reference still being made to FIG. 1, and in accordance with additional unique and novel features characteristic of the present invention, it has been noted, in connection with the dispensing of hot melt adhesives, and, in particular, during a typical deposition or application cycle, that when the hot melt adhesive applicator is disposed in its deactivated state, the pressure within the swivel joint assembly is substantially elevated to what is commonly known in the industry as “dead-head pressure”. Under such conditions, the pressure can reach a pressure level that is within the range of, for example, 300-800 psi. As a result of such elevated pressure conditions attendant, for example, the inactive stage of the hot melt adhesive dispensing or application cycle, conventional swivel joint assemblies, defined between the housing section, to which the hot melt adhesive inlet supply hose is connected, and the shaft section, to which the hot melt adhesive applicator is connected, often experience “hydraulic lock” whereby the shaft section, to which the hot melt adhesive applicator is connected, often cannot be rotated. Accordingly, the hot melt adhesive applicator is incapable of being moved from the aforenoted predetermined DISPENSING position or orientation to the predetermined NON-DISPENSING position or orientation, or if such movement is in fact possible, it is often extremely difficult to achieve and can usually be achieved only as a result of the galling or scarring of the relatively movable wall surface portions of the housing and shaft components. This phenomena may in fact lead to additional frictional and seizure problems for the relatively movable housing and shaft components. It has also been noted that the aforenoted operational movements between the relatively movable housing and shaft components are exacerbated by means of the fact that since the system or assembly has hot melt adhesive materials flowing therethrough, the structural components are subjected to elevated temperature conditions which tend to cause the system or assembly components to undergo thermal expansion. Still further, hot melt adhesive materials are normally characterized by means of relatively high viscosity values which would also militate against achieving substantially easy and smooth relative rotation between the aforenoted system or assembly housing and shaft components.

Therefore, in accordance with the unique and novel principles and teachings of the present invention, it is also appreciated from FIG. 1 that an annular array of ball bearing members 30 are effectively interposed between the inner peripheral wall portion 32 of the outer or external housing member 12 and the outer peripheral wall portion 34 of the inner or internal shaft member 14. In particular, inner and outer ball bearing races 36,38 are respectively defined within the outer peripheral wall portion 34 of the inner or internal shaft member 14, and within the inner peripheral wall portion 32 of the outer or external housing member 12. In order to facilitate the insertion and disposition of the ball bearing members 30 within the aforenoted ball bearing races 36,38, an internally threaded insert opening or aperture 40 is defined within a wall portion of the housing member 12, and a cap screw 42 is adapted to be threadedly engaged within the opening or aperture 40 once the ball bearing members 30, and suitable grease or lubricant, have been deposited internally within the swivel joint assembly 10. In conjunction with the annular array of ball bearing members 30, it is further noted that a pair of rotary-type O-ring members or seals 44, 46 are respectively provided within recessed portions 48,50 and are disposed upon opposite sides of the ball bearing members 30. The O-ring member or seal 44 effectively prevents the ingress of any external debris from entering the swivel joint assembly 10 so as not to foul the ball bearing members 30, while the O-ring member or seal 46 prevents any hot melt adhesive disposed internally within the swivel joint assembly 10 from likewise fouling the ball bearing members 30.

In view of the fact that the swivel joint assembly housing and shaft members 12,14 are both fabricated from a suitable metal material, such housing and shaft members 12,14 are extremely good heat or thermal conductors. Accordingly, it is imperative that the O-ring or seal members 44,46 are fabricated from a suitable material that can withstand such heat or thermal levels which are characteristic of hot melt adhesive applications, such as, for example, within the range of 300-600° F., such that the O-ring or seal members do not thermally deteriorate and cause vapor lock. It is therefore to be appreciated that hot melt adhesive applications are significantly different than other fluid connectors, such as, for example, those utilized in conjunction with the transmission of hydraulics, liquid coolants, fuels, and the like. In accordance with the principles and teachings of the present invention, the O-ring or seal members 44,46 are preferably fabricated from FKM(VITON)®, which is a fluorocarbon elastomer manufactured by the DUPONT® corporation, or alternatively, the O-ring or seal members 44,46 may likewise be fabricated from FFKM(KALREZ)®, which is a perfluoro elastomer which is also manufactured by the DUPONT® corporation. It may therefore be appreciated further that when the hot melt adhesive applicator is disposed in its deactivated state, wherein the pressure within the swivel joint assembly is substantially elevated to the aforenoted “dead-head pressure” levels on the order of, for example, 300-800 psi, the shaft section 14, to which the hot melt adhesive applicator 21 is connected, is nevertheless able to be readily and easily rotated with respect to the housing section 12 to which the hot melt adhesive inlet supply hose 19 is connected.

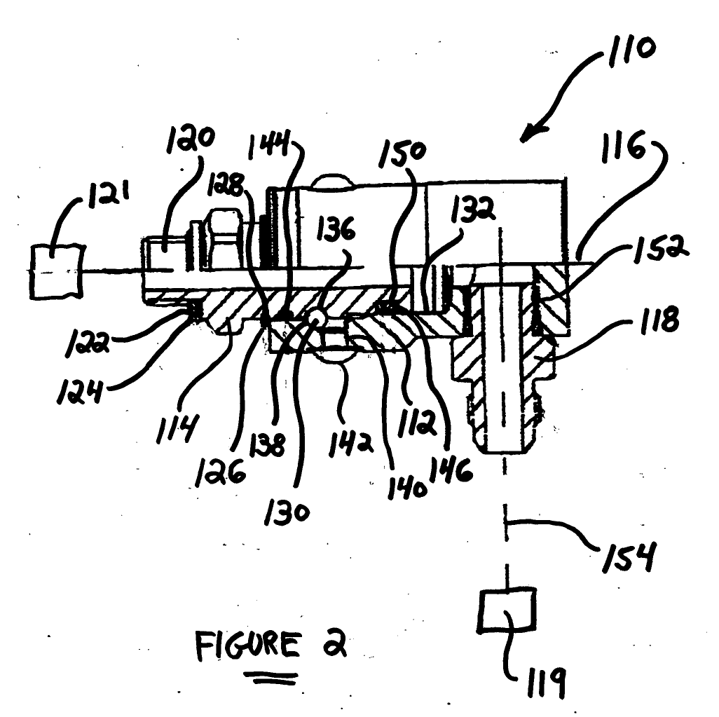

With reference now being made to FIG. 2, a second embodiment of a new and improved swivel joint assembly, which has also been constructed in accordance with the principles and teachings of the present invention, and which is adapted for use within a hot melt adhesive applicator or dispensing system, is disclosed and is generally indicated by the reference character 110. It is noted that in view of the structural similarities between the first and second embodiments 10, 110, of the new and improved swivel joint assemblies which have been developed in accordance with the principles and teachings of the present invention, a detailed description of the second embodiment of the swivel joint assembly will be omitted for brevity purposes except for the structural differences between the first and second embodiments 10,110, of the new and improved swivel joint assemblies. In addition, it is noted that structural components of the second embodiment of the swivel joint assembly 110 which correspond to the structural components of the first embodiment of the swivel joint assembly 10 have been designated by similar reference characters except that they will be within the 100 series. In accordance with the disclosure of the second embodiment of the swivel joint assembly 110 as illustrated within FIG. 2, it is seen that the only significant difference between the first and second embodiments of the swivel joint assemblies 10,110 resides in the fact that in lieu of the first threaded connector member 118 for fluidic connection to the hot melt adhesive supply hose, not shown, being integrally formed with the housing member 112, the first threaded connector member 118 comprises, in effect, a fitting or adaptor which is threadedly secured within an internally threaded bore 152 of the housing member 112. In addition, it is also seen that the axis 154 of the threaded connector member fitting or adaptor 118 is disposed substantially perpendicular to or at an angle of 90° with respect to the longitudinal axis 116 of the swivel joint assembly 110.

Thus, it may be seen that in accordance with the teachings and principles of the present invention, there has been provided a new and improved swivel joint assembly, for use within a hot melt adhesive applicator or dispensing system, which comprises an annular array of ball bearing members which is interposed between the housing section of the swivel joint assembly, to which the hot melt adhesive inlet supply hose is connected, and the shaft section of the swivel joint assembly, to which the hot melt adhesive applicator is connected, so as to readily facilitate the smooth rotation of the shaft section of the swivel joint assembly, to which the hot melt adhesive applicator is connected, with respect to the housing section of the swivel joint assembly, to which the hot melt adhesive inlet supply hose is connected, when the hot melt adhesive applicator is disposed in its deactivated state, at which time the pressure within the swivel joint assembly is substantially elevated. In this manner, the hot melt adhesive applicator can in fact be readily and easily moved from its predetermined DISPENSING position or orientation to its predetermined NON-DISPENSING position or orientation in order to accommodate or permit the movement of auxiliary apparatus into engagement with at least one of two structural components to be adhered together, and upon at least one of such structural components there has previously been deposited the predetermined amount of hot melt adhesive, so as to in fact cause the adherence together of the two structural components. In addition, the special packing materials, such as, for example, FKM(VITON)®, or alternatively, FFKM(KALREZ)®, are disposed within the swivel joint assembly so as to provide the necessary sealing of the swivel joint assembly in connection with the handling or flow of the hot melt adhesive materials therethrough without experiencing or undergoing thermal deterioration.

Obviously, many variations and modifications of the present invention are possible in light of the above teachings. It is therefore to be understood that within the scope of the appended claims, the present invention may be practiced otherwise than as specifically described herein.

1. A swivel joint assembly, for use within a hot melt adhesive dispensing system, comprising:
a housing member defined about a longitudinal axis;
a first connector mounted upon said housing member for connection to a hose member for supplying hot melt adhesive material into said housing member;
a shaft member disposed within said housing member for rotation around said longitudinal axis of said housing member between a DISPENSING position and a NON-DISPENSING position;
a second connector mounted upon said shaft member for connection to a hot melt adhesive applicator for dispensing hot melt adhesive material onto a substrate during a hot melt adhesive material application phase of a hot melt adhesive material application cycle; and
ball bearing means interposed between said shaft member and said housing member for facilitating said rotation of said shaft member around said longitudinal axis of said housing member between said DISPENSING position and said NON-DISPENSING position despite a substantial increase in line pressure of the hot melt adhesive material, disposed within said swivel joint assembly when the hot melt adhesive applicator is deactivated so as not to dispense any hot melt adhesive material, wherein such increased line pressure would normally tend to prevent said rotation of said shaft member with respect to said housing member due to hydraulic lock conditions.

2. The swivel joint assembly as set forth in claim 1, wherein:
said ball bearing means comprises an annular array of ball bearing members disposed around said longitudinal axis of said housing member.

3. The swivel joint assembly as set forth in claim 1, further comprising:
rotary seal members interposed between said shaft member and said housing member for sealing the interface defined between said shaft member and said housing member so as to prevent the hot melt adhesive, disposed within said swivel joint assembly, from fouling said ball bearing means.

4. The swivel joint assembly as set forth in claim 1, further comprising:
rotary seal members interposed between said shaft member and said housing member for withstanding elevated temperature levels characteristic of the hot melt adhesive disposed within said swivel joint assembly so as to ensure the sealing of the interface defined between said shaft member and said housing member.

5. The swivel joint assembly as set forth in claim 4, wherein:
said rotary seal members are selected from the group comprising FKM(VITON)® and FFKM(KALREZ)®.

6. The swivel joint assembly as set forth in claim 1, wherein:
said housing member, said first connector mounted upon said housing member, said shaft member, and said second connector mounted upon said shaft member are all coaxially aligned with respect to each other along said longitudinal axis of said housing member.

7. The swivel joint assembly as set forth in claim 1, wherein:
said housing member, said shaft member, and said second connector mounted upon said shaft member are all coaxially aligned with respect to each other along said longitudinal axis of said housing member; and
said first connector mounted upon said housing member is disposed substantially perpendicular to said longitudinal axis of said housing member.

8. A hot melt adhesive dispensing system, comprising:
a housing member defined about a longitudinal axis;
a hose member for supplying hot melt adhesive material into said housing member;
a first connector mounted upon said housing member for enabling connection of said hose member to said housing member;
a shaft member disposed within said housing member for rotation around said longitudinal axis of said housing member between a DISPENSING position and a NON-DISPENSING position;
a hot melt adhesive applicator for dispensing hot melt adhesive material onto a substrate during a hot melt adhesive material application phase of a hot melt adhesive material application cycle;
a second connector mounted upon said shaft member for enabling connection of said hot melt adhesive applicator to said shaft member; and
ball bearing means interposed between said shaft member and said housing member for facilitating said rotation of said shaft member around said longitudinal axis of said housing member so as to rotatably move said hot melt adhesive applicator between said DISPENSING position and said NON-DISPENSING position despite a substantial increase in line pressure of the hot melt adhesive material, disposed within said swivel joint assembly when said hot melt adhesive applicator is deactivated so as not to dispense any hot melt adhesive material, wherein such increased line pressure would normally tend to prevent said rotation of said shaft member with respect to said housing member due to hydraulic lock conditions.

9. The hot melt adhesive dispensing system as set forth in claim 8, wherein:
said ball bearing means comprises an annular array of ball bearing members disposed around said longitudinal axis of said housing member.

10. The hot melt adhesive dispensing system as set forth in claim 8, further comprising:
rotary seal members interposed between said shaft member and said housing member for sealing the interface defined between said shaft member and said housing member so as to prevent the hot melt adhesive, disposed within said swivel joint assembly, from fouling said ball bearing means.

11. The hot melt adhesive dispensing system as set forth in claim 8, further comprising:
rotary seal members interposed between said shaft member and said housing member for withstanding elevated temperature levels characteristic of the hot melt adhesive disposed within said swivel joint assembly so as to ensure the sealing of the interface defined between said shaft member and said housing member.

12. The hot melt adhesive dispensing system as set forth in claim 11, wherein:
said rotary seal members are selected from the group comprising FKM(VITON)® and FFKM(KALREZ)®.

13. The hot melt adhesive dispensing system as set forth in claim 8, wherein:
said housing member, said first connector mounted upon said housing member, said shaft member, and said second connector mounted upon said shaft member are all coaxially aligned with respect to each other along said longitudinal axis of said housing member.

14. The hot melt adhesive dispensing system as set forth in claim 8, wherein:
said housing member, said shaft member, and said second connector mounted upon said shaft member are all coaxially aligned with respect to each other along said longitudinal axis of said housing member; and
said first connector mounted upon said housing member is disposed substantially perpendicular to said longitudinal axis of said housing member.

15. A method of operating a hot melt adhesive dispensing system, comprising the steps of:
connecting a hose member, for supplying hot melt adhesive material, to a housing member which is defined around a longitudinal axis;
connecting a hot melt adhesive applicator, for dispensing hot melt adhesive material onto a substrate during a hot melt adhesive material application phase of a hot melt adhesive material application cycle, to a shaft member which is disposed within said housing member for rotation around said longitudinal axis of said housing member between a DISPENSING position and a NON-DISPENSING position such that said hot melt adhesive applicator can move between said DISPENSING position and said NON-DISPENSING positions; and
interposing ball bearing means between said shaft member and said housing member for facilitating said rotation of said shaft member, and said hot melt adhesive applicator connected to said shaft member, around said longitudinal axis of said housing member between said DISPENSING position and said NON-DISPENSING position despite a substantial increase in line pressure of the hot melt adhesive material disposed within said swivel joint assembly, when said hot melt adhesive applicator is deactivated so as not to dispense any hot melt adhesive material, wherein such increased line pressure would normally tend to prevent said rotation of said shaft member with respect to said housing member due to hydraulic lock conditions.

16. The method as set forth in claim 15, further comprising the step of:
disposing said ball bearing means as an annular array of ball bearing members around said longitudinal axis of said housing member.

17. The method as set forth in claim 15, further comprising the step of:
interposing rotary seal members between said shaft member and said housing member for sealing the interface defined between said shaft member and said housing member so as to prevent the hot melt adhesive, disposed within said hot melt adhesive dispensing system from fouling said ball bearing means.

18. The method as set forth in claim 15, further comprising the step of:
interposing rotary seal members between said shaft member and said housing member for withstanding elevated temperature levels characteristic of the hot melt adhesive disposed within said hot melt adhesive dispensing system so as to ensure the sealing of the interface defined between said shaft member and said housing member.

19. The method as set forth in claim 18, further comprising the step of:
fabricating said rotary seal members from one of the group comprising FKM(VITON)® and FFKM(KALREZ)®.

20. The method as set forth in claim 15, further comprising the step of:
coaxially aligning said housing member, said first connector mounted upon said housing member, said shaft member, and said second connector mounted upon said shaft member with respect to each other along said longitudinal axis of said housing member.

21. The method as set forth in claim 15, further comprising the steps of:
coaxially aligning said housing member, said shaft member, and said second connector mounted upon said shaft member with respect to each other along said longitudinal axis of said housing member; and
orienting said first connector mounted upon said housing member substantially perpendicular to said longitudinal axis of said housing member.
